(19) United States
(12) Patent Application Publication
(10) Pub. No.: US 2007/0184400 A1
(43) Pub. Date: Aug. 9, 2007

(54) Orthodontic spring for treatment of an impacted molar

(76) Inventor: Velton C. White, Burlington, WI (US)

Correspondence Address: DORR, CARSON & BIRNEY, P.C.;ONE CHERRY CENTER, 501 SOUTH CHERRY STREET, SUITE 800, DENVER, CO, 80246, US

(21) Appl. No.: 11/347,184

(22) Filed: Feb. 3, 2006

(51) Int. Cl. A61C 3/00

(52) U.S. Cl. 433/21

(57) ABSTRACT

An orthodontic spring for treatment of an impacted molar has two opposing sharp ends for sub-gingival insertion against the impacted molar and an adjacent molar, and a midsection that doubles back on itself and wraps over the interproximal contact between the molars in a mesio-distal direction. The tip of the midsection can extend into the space on the opposing lateral side between the molars to removably secure the spring to the molars. An elastomeric spacer can be attached to the midsection tip to exert additional force separating the molars.

### BACKGROUND OF THE INVENTION

### FIELD OF THE INVENTION

The present invention relates generally to the field of orthodontics. More specifically, the present invention discloses an orthodontic spring for treatment of an impacted molar.

Statement of the Problem

Impacted molars are a common problem encountered in dentistry. In particular, a molar may not erupt through the gum or may only partially erupt due to obstruction with the adjacent molar. This is typically due to a combination of forward rotation of the impacted molar and lack of adequate space between the impacted molar and the adjacent molar. For example, a third molar (or wisdom tooth) can become impacted against an adjacent second molar, or a second molar can become impacted against an adjacent first molar.

If the impacted molar has partially erupted, the result can be infections of the surrounding tissue and tooth decay caused by food trapped adjacent to the exposed portions of the impacted molar. An impacted molar also tends to exert forces that can crowd adjacent teeth and hinder proper arch form development. This can adversely affect the patient's dental appearance, and tooth and jaw alignment.

One common treatment has been to surgically excise the impacted molar. This procedure requires local or general anesthetic. It also carries the associated risk of infection and usually requires a significant period of time for patient recovery.

In some cases, an orthodontic bracket can be attached to a partially-erupted molar and then conventional orthodontic devices and techniques can be employed to move the impacted molar. However, this is possible only in a relatively small percentage of cases and this approach is not widely used in the orthodontic community.

Another approach has been to insert a small spring between the impacted molar and the adjacent molar to exert a force to separate these teeth. For example, Ortho Technology, Inc. of Tampa, Fla., markets such a deimpacter spring. Conventional deimpacter springs have generally suffered from two shortcomings. First, it is quite easy for a small spring to become dislodged over the course of treatment, particularly as the teeth separate. This creates a risk that the loose spring could be accidentally aspirated or swallowed by the patient. Second, space constraints between the impacted molar and the adjacent molar typically dictate that the deimpacter spring must have a relatively small size. In turn, this results in a spring having a relatively high spring constant acting over a relatively small range of motion. This can initially exert forces far in excess of those deemed therapeutically optimal for moving a molar.

Solution to the Problem

Nothing in the prior art shows an orthodontic spring having the structure of the present invention. In particular, the present spring has a shape designed to minimize the risk that the spring will become accidentally dislodged. In addition, the longer effective length of the spring allows gentler and more constant forces to be exerted between the impacted molar and the adjacent molar.

### SUMMARY OF THE INVENTION

This invention provides an orthodontic spring having two opposing sharp ends for sub-gingival insertion against an impacted molar and an adjacent molar, and a midsection that doubles back on itself and wraps over the interproximal contact between the molars in a mesio-distal direction. The tip of the midsection can extend into the space on the opposing lateral side between the molars to removably secure the spring to the molars. An elastomeric spacer can be attached to the midsection tip to exert additional force separating the molars.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a front perspective view of the orthodontic spring 10.

FIG. 2 is a front elevational view of the orthodontic spring 10.

FIG. 3 is a left side elevational view of the orthodontic spring 10.

FIG. 4 is a rear elevational view of the orthodontic spring 10.

FIG. 5 is a perspective view of the orthodontic spring 10 with protective tube 30 covering the sharp ends 11 and 12 of the orthodontic spring 10.

FIG. 6 is a perspective view showing initial installation of the orthodontic spring 10 between two molars 50, 51 using forceps 45. A dental mirror 40 is included in this view to reflect the lingual sides of the molars 50, 51 and the midsection 15 of the orthodontic spring 10.

FIG. 7 is a perspective view corresponding to FIG. 6 after installation of the orthodontic spring 10.

FIG. 8 is a perspective view corresponding to FIGS. 6 and 7 after a period of treatment has elapsed and the separation between molars 50, 51 has increased to some extent due to the forces exerted by the orthodontic spring 10.

FIG. 9 is a perspective view of the orthodontic spring 10 and elastomeric spacer 22, 24.

FIG. 10 is a perspective view corresponding to FIGS. 6-8 after installation of the elastomeric spacer on the orthodontic spring 10.

FIG. 11 is a perspective view corresponding to FIGS. 6-8 and 10 after a further period of treatment has elapsed following installation of the elastomeric spacer on the orthodontic spring 10.

FIG. 12 is an x-ray view of a portion of a patient's dental anatomy showing an impacted third molar 50.

FIG. 13 is an x-ray view corresponding to FIG. 12 after installation of the orthodontic spring 10 and a period of treatment has elapsed.

FIG. 14 is an x-ray view corresponding to FIGS. 12 and 13 after a further period of treatment has elapsed.

### DETAILED DESCRIPTION OF THE INVENTION

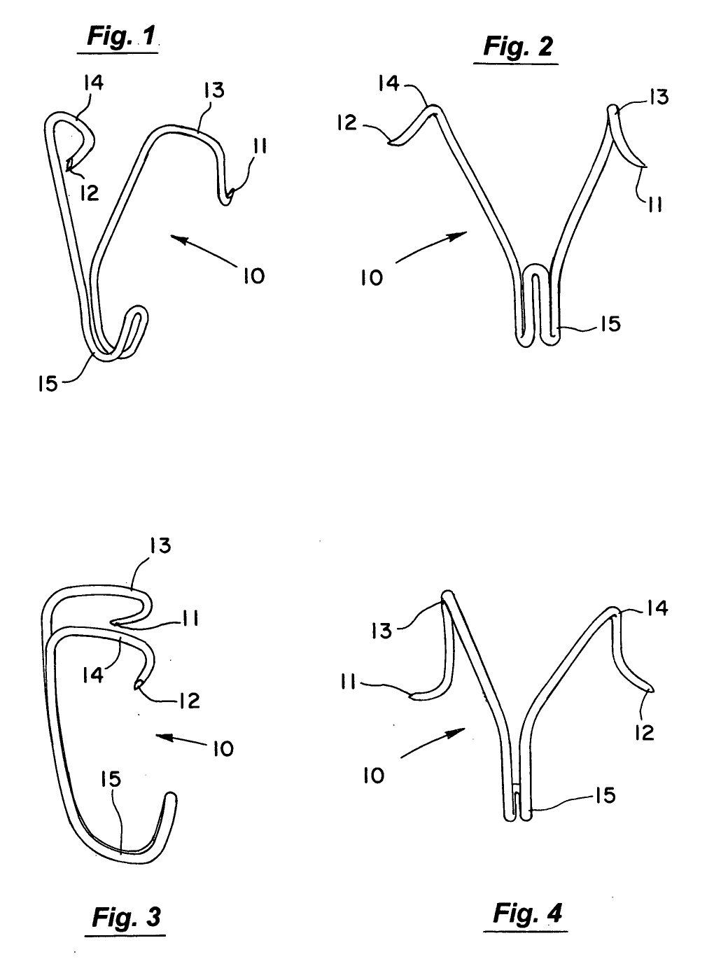

Turning to FIG. 1, a front perspective is provided of the present orthodontic spring 10. FIG. 2 is a corresponding front elevational view. FIG. 3 is a corresponding left side elevational view and FIG. 4 is a rear elevational view of the orthodontic spring 10. In this embodiment, the spring 10 consists of a single piece of wire having sharp ends 11, 12 at opposing ends for sub-gingival insertion. For example, the orthodontic spring 10 can be made of conventional nickel-titanium wire. Alternatively, the spring 10 could be made of a chromium-cobalt alloy.

Preferably, the ends 11, 12 are sufficiently sharp to pierce the soft tissue and extend into the periodontal membrane adjacent to the molars 50, 51. This intimate contact with the molars helps to hold the spring 10 in place and helps to ensure that the spring exerts an effective therapeutic force on the molars 50, 51. The portions of the spring 10 adjacent to the ends 13, 14 are curved to follow the contours of the molars 50 and 51, and thereby increase the areas of contact between the spring 10 and the molars 50, 51 for exertion of therapeutic forces.

The midsection 15 of the spring 10 doubles back on itself with a curvature to wrap over the interproximal contact between the second and third molars 51 and 50 in the lingual-buccal direction. In addition, the midsection 15 presents a curved, smooth surface on the lingual side for the tongue to increase patient comfort. The folded tip of the midsection 15 extends into the space between the interproximal contact between the molars 50, 51 and the gum to help hold the spring 10 in place.

After installation, the spring 10 exerts a force vector having horizontal, vertical and transverse components that remodel the supporting alveolar bone in such a way as to move the impacted tooth with its socket and supporting bone as a physiologic unit. Typically, this entails moving the third molar 50 posteriorly, thereby opening a space between the second molar 51 and third molar 50, and also rotating the third molar 50 into a more upright position. The folded midsection 15 allows the spring to have a greater effective length. The longer wire results in a more constant and gentler spring rate, which produces a more effective force gradient.

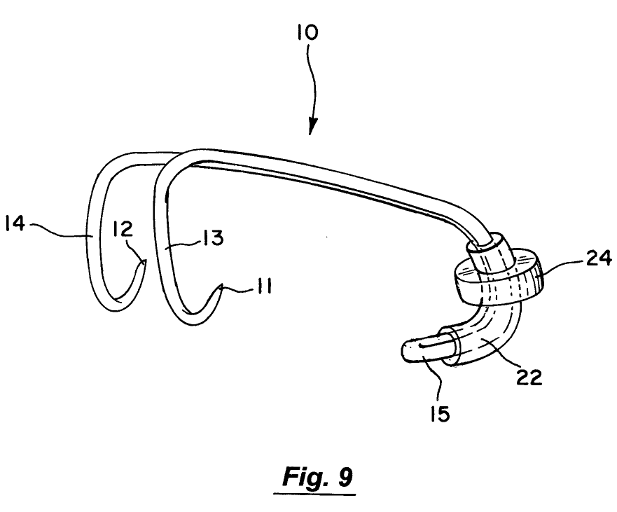

Optionally, an elastomeric spacer 22, 24 can be attached to the midsection 15 of the spring 10, as shown in FIG. 9, to wedge between the molars 50, 51. This elastomeric material adds additional reach interproximally and exerts an additional force separating the molars 50, 51. Additionally, the elastomeric spacer adds girth to fill the space between the molars 50, 51, which helps to hold the orthodontic spring 10 in place between the molars 50, 51. Otherwise, the midsection 15 of the orthodontic spring 10 may tend to move upward and outward from between the molars 50, 51 as the separation between the molars 50, 51 increases over the course of treatment. For example, elastomeric tubing 22 and/or a number of elastomeric rings 24 can be slipped over the folded midsection 15 of the spring 10 to serve as elastomeric spacers. Annular shapes in a wide range of dimensions and with suitable material properties can be easily slipped over folded tip of the midsection 14 of the spring 10.

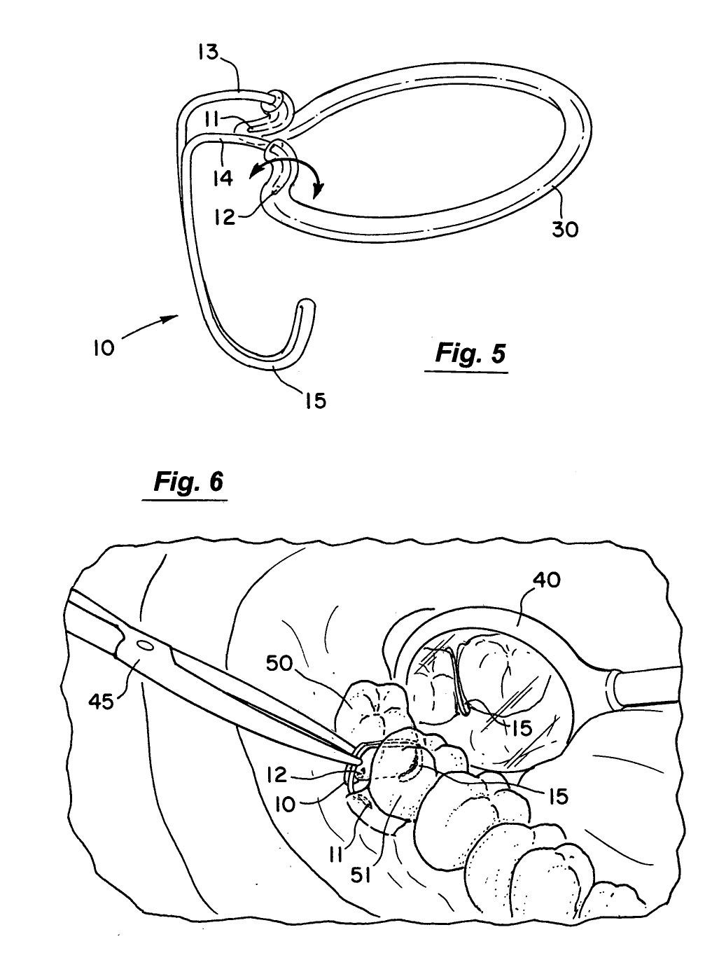

Installation of the orthodontic spring 10 is illustrated in FIGS. 5-7. FIG. 5 is a perspective view of the spring 10 with a protective loop of elastomeric tubing 30 covering the sharp ends 11 and 12 of the orthodontic spring 10 as a safety feature. An incision can be made in the patient's gingival to expose a portion of the mesial surface of the impacted molar 50 and/or the distal surface of the adjacent second molar 51, if necessary. The orthodontist initially grasps the curved end portions 13, 14 of the spring 10 with forceps 45. The forceps are used to compress the curved ends 13, 14 of the spring 10 during insertion of the spring. The compressed spring 10 is then inserted between the molars 50, 51, so that the sharp ends 11, 12 subgingivally pierce the soft tissue, extend through the periodontal membrane, and contact the molars 50, 51. The curved portions 13, 14 of the spring 10 adjacent to the sharp ends 11, 12 move into contact with the anterior surface of the impacted molar 50 and posterior surface of the adjacent molar 51, respectively.

The folded midsection 15 is positioned to wrap over the interproximal region between the molars 50, 51 in a mesio-distal direction. The folded tip of the midsection 15 extends into the space beneath the point of contact between the molars and above the gum on the opposing lateral side of the molars 50, 51 to help hold the spring 10 in place.

Preferably, the spring 10 is inserted from the buccal side of the molars 50, 51 with the midsection 15 extending to the lingual side. This provides the best field of view and access for the orthodontist during installation of the spring 10. But, it should be understood that the spring 10 could be inserted from either side of molars 50, 51. FIG. 6 is a perspective view showing initial installation of the spring 10 from the buccal side. A dental mirror 40 is included in this view to reflect the lingual sides of the molars 50, 51 and the midsection 15 of the spring 10.

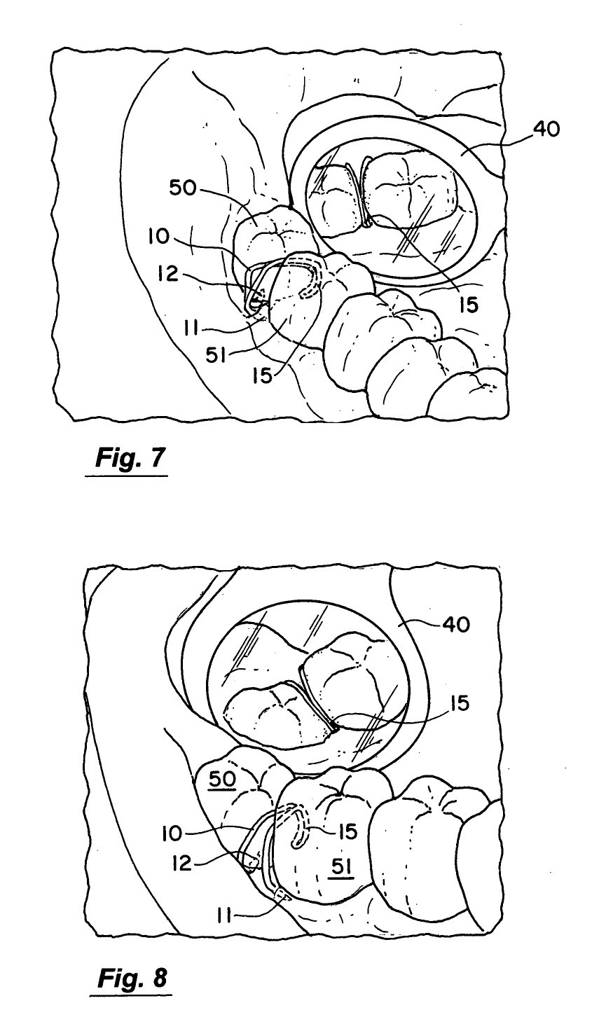

The orthodontist releases the spring 10 from the forceps 45 to complete its initial installation. The spring 10 expands and exerts a force separating the molars 50, 51. FIG. 7 is a perspective view corresponding to FIG. 6 after installation of the spring 10. FIG. 8 is a corresponding perspective view after a period of treatment has elapsed and the separation between molars 50, 51 has increased due to the force exerted by the spring 10.

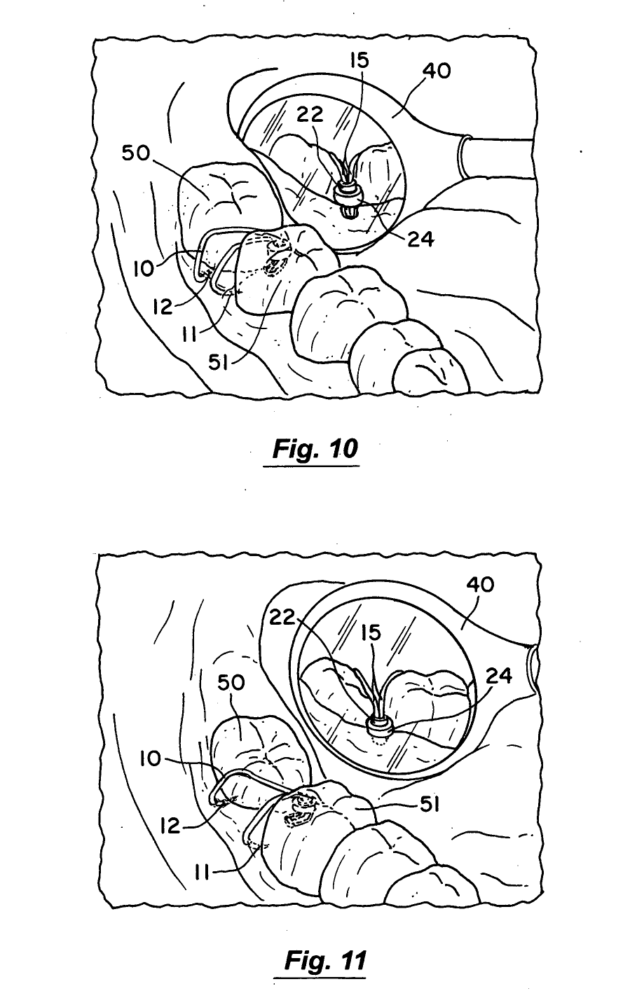

Optionally, an elastomeric spacer can be attached over the midsection 15 of the spring 10 at some point during treatment. Typically, an elastomeric spacer is slipped over the folded tip of the midsection 15 of the spring 10 after an initial period of treatment to further increase the separation of the molars 50, 51. FIG. 10 is a perspective view corresponding to FIGS. 6 through 8 after installation of the elastomeric spacer on the spring 10. The elastomeric spacer provides a wedging action as the contacts open and space develops between the teeth 50, 51. FIG. 11 is a perspective view corresponding to FIGS. 6-8 and 10 after a further period of treatment has elapsed following installation of the elastomeric spacer on the orthodontic spring 10. Optionally, a series of springs having difference dimensions and properties, and/or a series of spacers can be employed over the course of treatment.

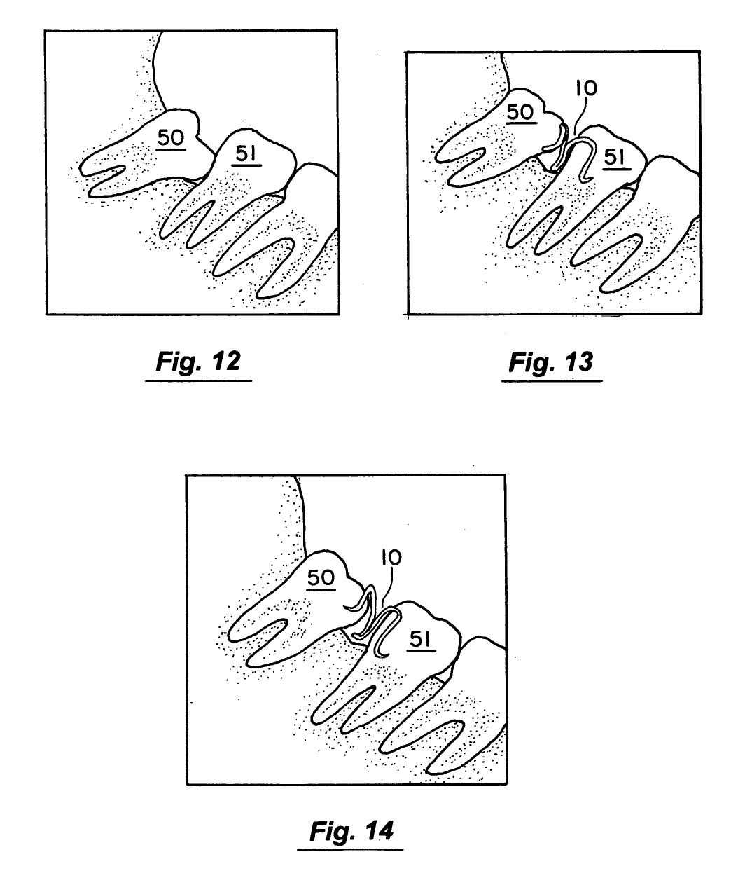

The progressive movement of the third molar 50 over the course of treatment is also shown in the x-ray views provided in FIGS. 12 through 14. FIG. 12 shows an impacted third molar 50 prior to treatment. FIG. 13 is a corresponding view after installation of the spring 10 and a period of treatment has elapsed. FIG. 14 is a corresponding view after a further period of treatment has elapsed.

The structure of the orthodontic spring 10, and in particular the longer effective length of the spring results in a relatively constant, continuous and optimal force vector to be applied to the impacted tooth. The force vector includes horizontal, vertical and transverse components that remodel the supporting alveolar bone in such a way as to move the impacted tooth with its socket and supporting bone as a physiologic unit. As a result, x-ray images of the alveolar bone in proximity of the impacted tooth in patients treated using the present invention do not exhibit osteoblasts (+) on the tension side of osteoclasts (−) on the pressure side, contrary to traditional orthodontic treatment. There is also little, if any, resorbtion of the roots of the impacted tooth. In addition, the reciprocal forces for each of the three components of the force vector exerted by the spring 10 are subliminal on all the other teeth (except the impacted tooth) and result in negligible if any tooth movement of the other teeth. The time of treatment and patient discomfort are greatly reduced over conventional orthodontic treatment.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

1. An orthodontic spring for treatment of an impacted molar by inserting the spring in compressed form between the impacted molar and an adjacent molar, said spring comprising:
a first end portion having a sharp end for sub-gingival insertion from a first lateral side of the adjacent molar to contact the posterior surface of the adjacent molar;
a second end portion having a sharp end for sub-gingival insertion from the first lateral side of the impacted molar to contact the anterior surface of the impacted molar, so that following insertion of the spring between the molars, the spring exerts a force separating the molars; and
a midsection between the end portions doubling back on itself for wrapping over the interproximal contact between the molars in a mesio-distal direction.

2. The orthodontic spring of claim 1 and further comprising an elastomeric spacer attached to the midsection for exerting a force separating the molars.

3. The orthodontic spring of claim 1 further comprising an elastomeric spacer for attachment over the midsection after an initial period of treatment to increase the space between the molars.

4. The orthodontic spring of claim 1 further comprising a midsection tip defined by the doubling back of the midsection, for extending into the space between the molars on the opposing lateral side of the molars to thereby removably attach the spring to the molars.

5. The orthodontic spring of claim 1 comprising a chromium-cobalt alloy.

6. The orthodontic spring of claim 1 comprising a nickel-titanium alloy.

7. The orthodontic spring of claim 1 further comprising safety tubing removably covering the sharp ends prior to installation of the spring.

8. The orthodontic spring of claim 1 wherein the first end portion is curved for contacting the posterior surface of the adjacent molar.

9. The orthodontic spring of claim 1 wherein the second end portion is curved for contacting the anterior surface of the impacted molar.

10. An orthodontic spring for treatment of an impacted molar by inserting the spring in compressed form between the impacted molar and an adjacent molar, said spring comprising:
a first end portion having a sharp end for sub-gingival insertion from a first lateral side of the adjacent molar to contact the posterior surface of the adjacent molar;
a second end portion having a sharp end for sub-gingival insertion from the first lateral side of the impacted molar to contact the anterior surface of the impacted molar, so that following insertion of the spring between the molars, the spring exerts a force separating the molars;
a midsection between the end portions doubling back on itself for wrapping over the interproximal contact between the molars in a mesio-distal direction to the opposing lateral side of the molars; and
a spacer attached to the midsection on the opposing lateral side of the molars for contacting the anterior surface of the impacted molar and the posterior surface of the adjacent molar to exert a force separating the molars.

11. The orthodontic spring of claim 10 wherein the spacer comprises an elastomeric material.

12. The orthodontic spring of claim 10 wherein the spacer has a substantially annular shape.

13. The orthodontic spring of claim 10 further comprising a midsection tip defined by the doubling back of the midsection for extending into the space between the molars on the opposing lateral side of the molars to thereby removably attach the spring to the molars.

14. The orthodontic spring of claim 13 wherein the spacer is attached to the midsection tip.

15. The orthodontic spring of claim 10 comprising a chromium-cobalt alloy.

16. The orthodontic spring of claim 10 comprising a nickel-titanium alloy.

17. An orthodontic spring for treatment of an impacted molar by inserting the spring in compressed form between the impacted molar and an adjacent molar, said spring comprising:
a first end portion having a sharp end for sub-gingival insertion from a first lateral side of the adjacent molar to contact the posterior surface of the adjacent molar;
a second end portion having a sharp end for sub-gingival insertion from the first lateral side of the impacted molar to contact the anterior surface of the impacted molar, so that following insertion of the spring between the molars, the spring exerts a force separating the molars; and
a midsection between the end portions doubling back on itself to define a midsection tip for wrapping over the interproximal contact between the molars in a mesio-distal direction with the midsection tip extending into the space between the molars on the opposing lateral side of the molars to thereby removably attach the spring to the molars.

18. The orthodontic spring of claim 17 further comprising a spacer attached to the midsection tip for exerting a force separating the molars.

19. The orthodontic spring of claim 18 wherein the spacer has a substantially annular shape.

20. The orthodontic spring of claim 17 comprising a chromium-cobalt alloy.
